(19) United States
(12) Patent Application Publication
(10) Pub. No.: US 2025/0225529 A1
(43) Pub. Date: Jul. 10, 2025

(54) PROTECTIONS FOR STORED DATA

(71) Applicant: MASTERCARD INTERNATIONAL INCORPORATED, Purchase, NY (US)

(72) Inventors: Kathy Ann Simon, St. Peters, MO (US); Amanda Brizendine, Wentzville, MO (US); Joel Birke, Ballwin, MO (US)

(21) Appl. No.: 18/409,227

(22) Filed: Jan. 10, 2024

(51) Int. Cl. G06Q 20/42; G06Q 20/34; G06Q 20/40

(52) U.S. Cl. CPC G06Q 20/42; G06Q 20/351; G06Q 20/409

(57) ABSTRACT

A method for tracking storage of payment card details at various entities includes, receiving, over a payment network, a plurality of transaction messages and non-financial advice messages; identifying, from the plurality of transaction messages and non-financial advice messages, a non-financial advice message comprising a card-on-file (COF) notice, a merchant ID, and payment card information; identifying, from the payment card information, an issuer associated with the payment card details; sending a COF message indicating storage of the payment card details at the merchant to the issuer; and receiving, from the issuer, confirmation that the payment card is recorded as a COF.

### BACKGROUND

The number of entities receiving and storing payment card details continues to rapidly increase with the prominence and convenience of online retail and the increased use of digital FinTech providers. It has become easier, and more convenient, for users to store payment card details at an entity, for example by authorizing a payment card used in a transaction to be stored as a card-on-file for use in future purchases. As more users continue to store their payment card details with various entities, it can be difficult to consistently and accurately track all of the places where those payment card details are being stored. The use of payment card details when setting up accounts even when no transaction ultimately takes place makes it even harder to track where one's card details are stored since reviewing payment card transactions would not reveal the entity storing the payment card details. The inability to maintain full visibility and control of one's payment card information is a security risk.

When breaches or other security threats occur at entities storing payment card details, it can be extremely useful to know whether your payment card details were being stored by that merchant and are potentially at risk. Without adequate knowledge of where payment card details are stored, it is difficult to efficiently act when the security of the entities storing these details are compromised. It would be unreasonable for every payment card customer to cancel all current payment cards and apply for replacements each time an entity that may be storing their payment card details has been compromised.

Therefore, there is a need to facilitate comprehensive tracking of what entities are storing payment card details to provide users with both complete visibility of where payment card details are being stored and simple methods of managing the storage of their payment card details.

### BRIEF SUMMARY

Systems and methods for tracking and managing entities storing payment card details are described that can provide improved protections for stored data. Through certain implementations of the described systems and techniques, it can be possible to track and manage payment card details at various entities, whether or not a transaction was ever made using those payment card details.

A system on a payment network can facilitate a method for tracking storage of payment card details at various entities by receiving, over the payment network, a plurality of transaction messages and non-financial advice messages; identifying, from the plurality of transaction messages and non-financial advice messages, a non-financial advice message comprising a card-on-file (COF) notice, a merchant identifier (ID), and payment card information, wherein the merchant ID corresponds to a merchant that received payment card details comprising the payment card information during a non-transaction event; identifying, from the payment card information, an issuer associated with the payment card details; sending a card-on-file (COF) message indicating storage of the payment card details at the merchant to the issuer; and receiving, from the issuer, confirmation that the payment card is recorded as a COF.

In some cases, the method for tracking storage of payment card details at various entities can include identifying, from the plurality of transaction messages and non-financial advice messages, a transaction message comprising a card-on-file (COF) indicator, a second merchant ID, second payment card information corresponding to a second payment card, and transaction information, wherein the second merchant ID corresponds to a second merchant at which a second payment card is authorized as a COF; identifying, from the second payment card information, a second issuer associated with the second payment card; requesting authorization or preauthorization for a second payment card corresponding to the second payment card information; receiving, from the issuer, authorization or preauthorization for the second payment card corresponding to the second payment card information; and receiving, from the issuer, confirmation that the second payment card is recorded as a second COF.

In some cases, the method for tracking storage of payment card details at various entities can include receiving, at the system on the payment network, a removal request message indicating that a user is requesting removal of the payment card as a COF at a particular merchant, wherein the removal request message comprises the merchant ID of the merchant; identifying, from the merchant ID, the merchant associated with the merchant ID; and sending a COF removal instruction to the merchant.

An issuer system receiving the COF information associated with the COF indicators from transaction messages and the COF notices from non-transaction messages sent over the payment network can store and manage the merchant information associated with the particular payment card referenced by the transaction messages and the non-transaction messages. The issuer system can provide an issuer application for users through which various functions can be performed with respect to user accounts.

In certain implementations, an issuer system in communication with a user device running an issuer application can perform a method including managing, at a storage resource, card-on-file (COF) information for payment cards the COF information comprising merchant identifiers (IDs) of merchants storing payment card details of a particular payment card during non-transaction events and merchant IDs of merchants storing the payment card details of the particular payment card as part of a transaction that includes COF authorization; receiving, at a graphical user interface (GUI) for the issuer application, a request to identify entities that have payment card information of the particular payment card stored on file; identifying, from the COF information at the storage resource, all merchants associated with the particular payment card, including any merchants that received the payment card details during non-transaction events; obtaining a merchant profile for each identified merchant associated with the particular payment card; and providing, for display at the GUI for the issuer application, the merchant profiles for each identified merchant such that a cardholder of the particular payment card is aware of which entities are storing the payment card information of the particular payment card, even when no transaction has occurred at that entity.

In some cases, managing, at the storage resource, COF information can include identifying, from the plurality of transaction messages and non-financial advice messages, a transaction message comprising a card-on-file (COF) indicator, a second merchant ID, second payment card information corresponding to a second payment card, and transaction information, wherein the second merchant ID corresponds to a second merchant at which a second payment card is authorized as a COF; identifying, from the second payment card information, a second issuer associated with the second payment card; requesting authorization or preauthorization for a second payment card corresponding to the second payment card information; receiving, from the issuer, authorization or preauthorization for the second payment card corresponding to the second payment card information; and receiving, from the issuer, confirmation that the second payment card is recorded as a second COF.

In some cases, managing, at the storage resource, COF information can include include receiving a removal request message indicating that a user is requesting removal of the payment card as a COF at a particular merchant, wherein the removal request message comprises the merchant ID of the merchant; identifying, from the merchant ID, the merchant associated with the merchant ID; and sending a COF removal instruction to the merchant.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional payment network process.

FIG. 2A illustrates an example process flow diagram for tracking storage of payment card details at various entities when there is no transaction.

FIG. 2B illustrates a method for tracking storage of payment card details at various entities performed at a system on a payment network.

FIG. 3A illustrates an example representation of a graphical user interface of an interactive COF report for controlling stored data associated with payment card details at various entities.

FIG. 3B illustrates a process flow diagram of controlling stored data associated with payment card details at various entities.

FIG. 3C illustrates an example method for controlling stored data associated with payment card details at various entities.

FIGS. 4A-4C illustrate a plurality of views of GUIs displayed at a digital wallet application. FIG. 4A illustrates an example representation of a “home” GUI at a digital wallet application. FIGS. 4B-4C illustrate example representations of interactive COF reports displayed in the graphical user interface at a digital wallet application.

FIG. 4D illustrates a process flow diagram for displaying a plurality of COF reports for a plurality of payment cards at a digital wallet application.

FIG. 4E illustrates a process flow diagram for requesting the removal of a particular payment card as a COF via a digital wallet application.

FIG. 5 illustrates an example operating environment for tracking and managing entities storing payment card information.

### DETAILED DESCRIPTION

Systems and methods for tracking and managing entities storing payment card details are described that can provide improved protections for stored data. Through certain implementations of the described systems and techniques, it can be possible to track and manage payment card details at various entities, whether or not a transaction was ever made using those payment card details. The present application describes systems and techniques to leverage the existing, secure payment pathways to track and manage the storage of payment card details at various entities.

A “payment network” refers to a network that routes transaction information to the appropriate issuer. An example of a payment network is the one operated by Mastercard International Incorporated.

A “merchant” refers to a provider of goods or services in exchange for payment. The merchant can be physically present at the sale or remote, such as an online retailer. For the purposes described herein, the term “merchant” includes any entity that receives and stores payment card details (e.g., FinTech providers, social media websites, etc.).

An “acquirer” refers to a party that acts as an intermediary between a merchant and the payment network. The acquirer processes payments on behalf of the merchant in a payment card transaction, for example, by managing the merchant account, authorizing transactions with an issuing bank, and facilitating of the settlement of funds. The acquirer can include or communicate with a payment processor to handle the authorization and secure transfer of transaction data (e.g., execution of the transaction). The acquirer/processor can be a bank system or other institution associated with the merchant.

An “issuer” refers to a bank system or other institution that provides payment cards to the cardholder.

As used herein, “payment card” or “card” can be a physical payment card or any non-physical equivalent, such as, for example, a virtual wallet application (also referred to as mobile wallet application) that supports mobile payment via a computing device such as a laptop computer, mobile phone, and wearable computing device (e.g., watch or glasses), and similar computing devices.

A “financial technology (FinTech) provider” refers to software, mobile applications, and other technologies that use and/or store payment card details of a payment card. For example, Apple® Wallet, Robinhood®, Venmo®, Facebook®, etc.

A “transaction message” refers to a message routed through the payment network that is associated with a transaction made using a payment card. The transaction message can include payment card information, a merchant identifier (ID), transaction information (e.g., a transaction total) and, in some cases, a card-on-file indicator.

A “non-financial advice message” (NFA message) refers to a message routed through the payment network that is not associated with performing a transaction. Advice messages can be used to provide confirmation or acknowledgment of certain states, for example, providing additional information between parties. For example, certain NFA messages, such as those including a “merchant advice code” (e.g., field DE48 SE84) or “recurring payment cancellation codes” function as explicit communication channels from issuers to merchants that can communicate information such as why a transaction was declined and what can be done to remedy the situation.

A “card-on-file” (COF) refers to stored payment card details authorized by a cardholder to be used in future purchases. A “COF transaction” refers to a transaction that involves the stored credentials of the cardholder. A COF payment may be cardholder-initiated (e.g., customer selecting previously stored card data to pay for goods) or merchant-initiated (e.g., subscriptions, installment plan, no-show charges). Conventionally, a COF can be authorized by a cardholder making a purchase and agreeing to store the COF for future transactions or by performing a zero-amount transaction on behalf of the cardholder.

A “COF indicator” refers to a value in a field of a transaction message that indicates that the payment card identified by the payment card information is being stored as a COF at the merchant identified by the merchant ID. In some cases, the data element DE48, sub-element 22 (multi-purpose merchant indicator) subfield 5 (cardholder/merchant initiated transaction indicator) can be used in an authorization request and/or financial transaction request message for a COF. For example, a certain value in this field may indicate that the cardholder is authorizing the merchant to store the cardholder's account data for subsequent use in connection with one or more later transaction(s) with that merchant and different values may indicate different COF arrangements.

A “COF notice” refers to a value in a field of an NFA message that indicates that the payment card identified by the payment card information is being stored as a COF at the merchant identified by the merchant ID.

A “non-transaction event” refers to an action taken at a merchant on behalf of a cardholder, but that does not involve a transaction for a sale of good. A non-transaction event can involve receipt of payment card details by a merchant without accompanying a transaction. For example, in the scenarios described herein, non-transaction events include storing payment card information at the merchant during creation of an online account for a cardholder.

Conventionally, payment networks facilitate payment card transactions by providing a communication system that issuing banks (issuers) and businesses (merchants) use to process payment card transactions so that funds can be transferred from a cardholder to a merchant. The majority of the messages sent via the payment network are messages that are associated with a transaction (e.g., transaction messages).

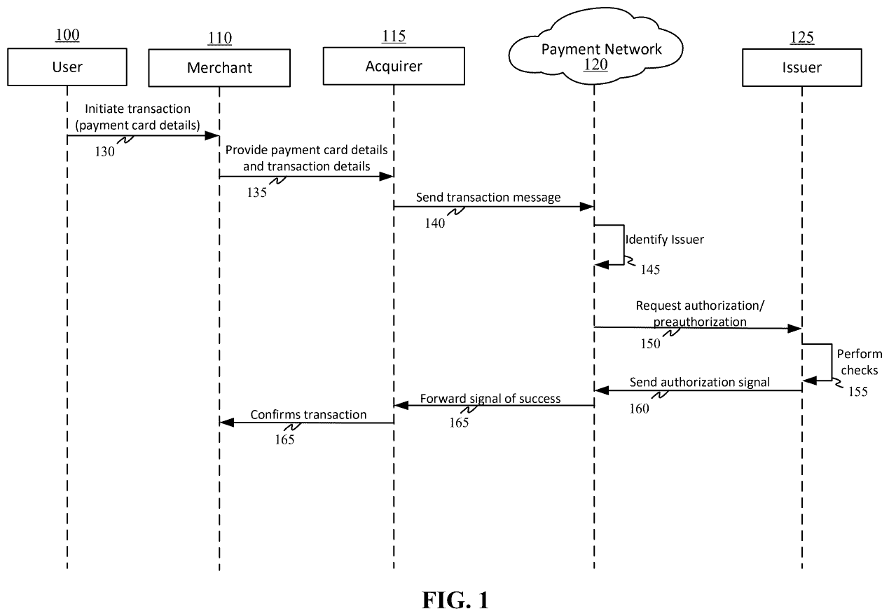

FIG. 1 illustrates an example conventional payment network process.

Referring to FIG. 1, in conventional payment card processes, there can be communication between a merchant 110, an acquirer 115, a payment network 120, and an issuer 125. These communications can include payment card authorization, clearing, and settlement.

A process of payment card authorization can begin when a customer makes a request from a merchant 110 to purchase a product or service and provides payment card details of a payment card and authorization to initiate (130) the transaction. In some cases, the cardholder uses a physical payment card. However, as used herein, a “payment card” or “card” can also be any non-physical equivalent, such as, for example, a virtual wallet application (also referred to as mobile wallet application) that supports mobile payment via a computing device such as a laptop computer, mobile phone, and wearable computing devices (e.g., watch), and similar computing devices.

The merchant 110 can provide (135) payment card details (e.g., the credit card number, confirmation code, and expiration date) and transaction details (e.g., location, amount, goods type, and a form of verification provided) to the acquirer 115. The acquirer 115 receives transactions from the merchant 110 via a payment gateway (e.g., a point of sale (POS) terminal or an online shopping cart or other payment application providing a point of interaction).

The acquirer 115 can, in turn, send (140) a transaction message to the payment network 120 to provide the information to the payment network 120 associated with the form of payment. The transaction message can include payment card information (e.g., some or all of the payment card details provided by the POS/POI for the merchant), transaction information (e.g., some or all of the transaction details provided by the POS/POI for the merchant), and a merchant ID.

The payment network 120 can identify (145) an issuing bank, or issuer 125, of the customer's form of payment using the payment card information included in the transaction information. The transaction can be logged to aid in later processes, such as clearing and settlement. When the payment network 120 identifies (145) the issuer 125, the payment network 120 can send some of the transaction message information and request (150) authorization and/or preauthorization on the payment method.

The issuer 125 can respond to the requested authorization or preauthorization. The pre-authorization confirms that the amount is available for the cardholder from the issuer 125 and can place a hold on the amount for a period of time. Authorization is an approval that indicates that the cardholder has sufficient funds/available credit to cover the cost of the transaction. The authorization process can also entail ensuring that a transaction is legitimate, such as by checking (155) the provided verification to confirm customer is legitimate cardholder, location to check against typical spending locations for the cardholder, and amount to ensure that the customer has sufficient funds/available credit to cover the cost of the transaction. After one or more checks are performed, the issuer 125 can accept the transaction and send (160) an authorization signal of success (or failure) back to the payment network 120.

Once the signal is received, the payment network 120 can forward (165) the signal of success to the acquirer 115. The acquirer 115 can then forward the signal back to the merchant 110 to confirm (165) that the transaction has been accepted. Later on, settlement and clearing can occur. In clearing, the payment information can be double-checked for accuracy. In settlement, the issuer 125 can transfer funds to the payment network 120; the payment network 120 can then transfer the funds to the acquirer 115. Once the acquirer 115 receives the funds, the funds can be made available to the merchant 110.

In some cases, the transaction can be a card-on-file (COF) transaction. For example, when the user initiates (130) the transaction, the user 100 can authorize the payment card information to be stored as a COF. In cases where the merchant 110 is storing, or has been authorized to store, the payment card as a COF, when the merchant 110 provides (135) the payment card details and transaction details to the acquirer 115, the merchant can include a COF indicator. The COF indicator indicates that the payment card identified by the payment card information is being stored as a COF at the merchant identified by the merchant ID.

The COF indicator can be sent (140) in the transaction message to the payment network 120 and also included alongside or as part of the request (150) for authorization/preauthorization. For example, the COF indicator may be included in a transaction message where a user has initiated a transaction and has agreed that the merchant may store the credential for future purchases.

When the issuer 125 receives payment information that includes a COF indicator, the issuer 125 can identify, from the COF indicator that the payment card indicated in the payment information is being stored as a COF at the merchant corresponding to the merchant ID). In some cases, the issuer 125 can send confirmation to the payment network 120 that the payment card has been recorded as a COF, along with the authorization/preauthorization message.

In the conventional process illustrated in FIG. 1, when the issuer receives a transaction message that includes a COF indicator, the issuer is able to track and record entities that are storing a particular payment card as a COF.

However, simply tracking COF information for merchants as indicated by COF indicators included in transaction messages fails to comprehensively track the entirety of the of all the entities storing payment card details of a particular payment card. Indeed, because the COF indicator is a feature of a transaction message, the issuer has no way of tracking the entities (e.g., merchants, FinTech providers, etc.) storing payment card details received during non-transaction events.

Several online retailers or mobile applications require payment information when setting up an account or performing other non-transaction events. For example, if a user wishes to make a payment with a gift card at the Apple® App Store, the user may be prompted to enter payment card details (e.g., name, card number, expiration date, etc.), even though that payment card will not be used as payment in the transaction. The payment card details may then be stored by the Apple® App Store as a COF for that account. In this case, because the payment card was not used in a transaction, no transaction message (including the COF indicator) was sent to the issuer. Therefore, the issuer cannot know that the payment card details associated with their customer's payment card are being stored by the Apple® App Store.

As an additional example, when creating an online account at Amazon.com, a user may be prompted to enter payment card details, to be stored by Amazon®, even before the user wishes to transact on the website. Again, the issuer will not receive a transaction message (e.g., as described with respect to FIG. 1), because no transaction has occurred. Therefore, the issuer, will be unaware that Amazon® is storing these payment card details as a COF. Furthermore, if the user never returns to the Amazon® site to make a purchase, then after a period of time, the user may forget that their credentials are stored with Amazon.

Advantageously, the described systems and methods facilitate comprehensive tracking, recording, and management to provide services so that a cardholder may identify and control what entities are storing payment card details, including merchants storing payment card details during non-transaction events and merchants storing payment card details as part of a transaction that includes COF authorization.

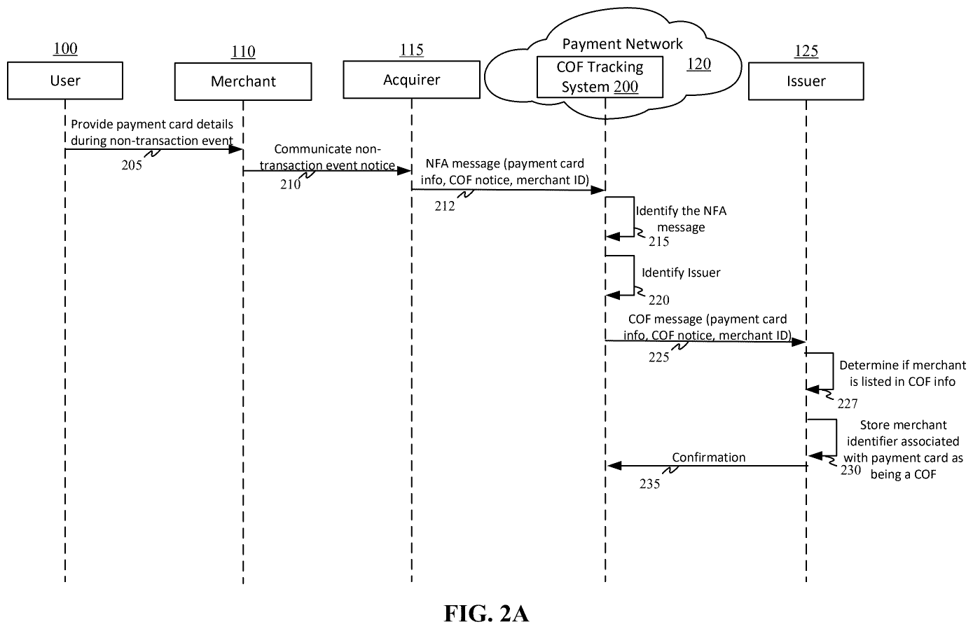

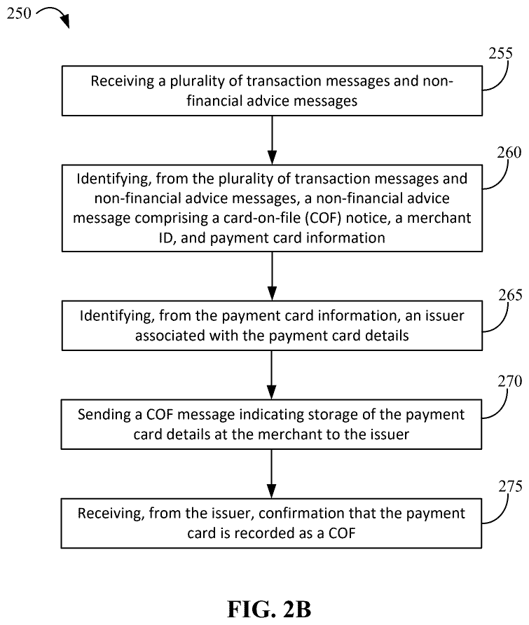

FIG. 2A illustrates an example process flow diagram for tracking storage of payment card details at various entities when there is no transaction; and FIG. 2B illustrates a method for tracking storage of payment card details at various entities performed at a system on a payment network.

Referring to FIG. 2A, with the inclusion of a COF tracking system 200, the conventional payment card rails including merchant 110, acquirer 115, payment network 120, and issuer 125 described with respect to FIG. 1 can be leveraged to support COF tracking even when there is no transaction. The COF tracking system 200 can facilitate the communication of both transaction messages and non-financial advice (NFA) messages between the merchant 110, the acquirer 115, and the issuer 125.

In the scenario illustrated in FIG. 2A, a user 100 may provide (205) payment card details to the merchant 110 during a non-transaction event. As explained above, a non-transaction event a non-transaction event can involve receipt of payment card details by a merchant 110 without accompanying a transaction. For example, the user 100 may have set up an account with the merchant 110, but not complete a purchase.

Advantageously, even though no transaction has occurred, the merchant 110 can communicate (210) a non-transaction event notice (e.g., notice that payment card details are being stored) to the acquirer 115. The non-transaction event notice can include payment card information (e.g., all or some of the payment card details). The acquirer 115 can generate and send (212) a non-financial advice (NFA) message to the payment network 120. The NFA message can include payment card information, a merchant ID associated with the merchant 110, and a COF notice. Advantageously, despite not being associated with a transaction, the NFA message is still sent via the conventional payment card rails existing on the payment network 120.

In some cases, in lieu of the acquirer 115, the merchant 110 can communicate the NFA message (or in some cases, the content of the NFA message) to the payment network 120 (e.g., via application programming interfaces (APIs) that may be provided by the COF tracking system 200 on the payment network 120); however, it is expected that there exists a communication relationship between such a merchant and the payment network 120.

The payment network 120 can receive a plurality of transaction messages (e.g., as illustrated in step (140) of FIG. 1) and non-financial advice messages (as illustrated in step (212) of FIG. 2A). The transaction messages can include COF indicators. The NFA messages can include COF notices.

Because the payment network 120 consistently receives a plurality of both transaction messages and NFA messages, as illustrated in the scenario shown in FIG. 2A, the COF tracking system 200 can identify (215), from the plurality of received transaction messages and NFA messages, the NFA message (including a COF notice, a merchant ID, and payment card information) received from the acquirer 115. When the COF tracking system 200 identifies (215) the NFA message including a COF notice, the COF tracking system 200 can identify (220) the issuer 125 corresponding to the payment card information included in the NFA message.

Once the COF tracking system 200 identifies (220) the issuer 125, the COF tracking system 200 can send (225) a COF message to the issuer 125. The COF message to the issuer 125 can include the COF notice, the merchant ID, and the payment card information. In some cases, the COF message is an NFA message generated by the payment network 120. In some cases, the payment network 120 can send (225) the COF message to the issuer 125 via an API provided by the payment network 120.

When the issuer 125 receives the COF message, the issuer 125 can determine (227) whether the merchant 110 associated with the merchant ID is listed in the stored COF information for the payment card at a storage resource. The stored COF information can include a list of merchants that the issuer tracks based on the received COF notices and COF indicators. If the merchant 110 is not listed in the COF information for the payment card, the issuer 125 can store (230) an identifier of the merchant 110 associated with the payment card/cardholder account as being a COF at the storage resource.

After checking and optionally updating the COF information at the storage resource, the issuer 125 can send (235) confirmation that the payment card has been recorded as a COF associated with the merchant 110 to the COF tracking system 200. In some cases, the issuer 125 sends (235) confirmation that the payment card is recorded as a COF via an API provided by the payment network 120. In some cases, the issuer 125 sends (235) confirmation that the payment card is recorded as a COF via an NFA message.

Accordingly, referring to FIG. 2B, the COF tracking system 200 can perform method 250 including receiving (255) a plurality of transaction messages and non-financial advice (NFA) messages; identifying (260), from the plurality of transaction messages and NFA messages, a non-financial advice message comprising a card-on-file (COF) notice, a merchant ID, and payment card information, wherein the merchant ID corresponds to a merchant that received payment card details including the payment card information during a non-transaction event; identifying (265), from the payment card information, an issuer associated with the payment card details; sending (270) a COF message indicating storage of the payment card details at the merchant to the issuer; and receiving (275) confirmation from the issuer that the payment card is recorded as a COF.

Advantageously, because the issuer 125 is not only receiving transaction messages with COF indicators (as described with respect to FIG. 1), but is also receiving NFA messages with COF notices, the issuer 125 has visibility on all entities where a payment card is being stored, regardless of whether a transaction was made at that entity or not.

The issuer 125 can leverage the payment network 120 (e.g., the COF tracking system 200), to securely obtain information on what entities are storing payment card details for payment cards associated with their cardholders. The issuer 125 can store records of what entities are storing payment card details for a particular payment card as COF information. Indeed, the issuer 125 obtains COF information from transaction messages including COF indicators (e.g., as described with respect to FIG. 1) and from NFA messages including COF notices (e.g., as described with respect to FIGS. 2A-2B).

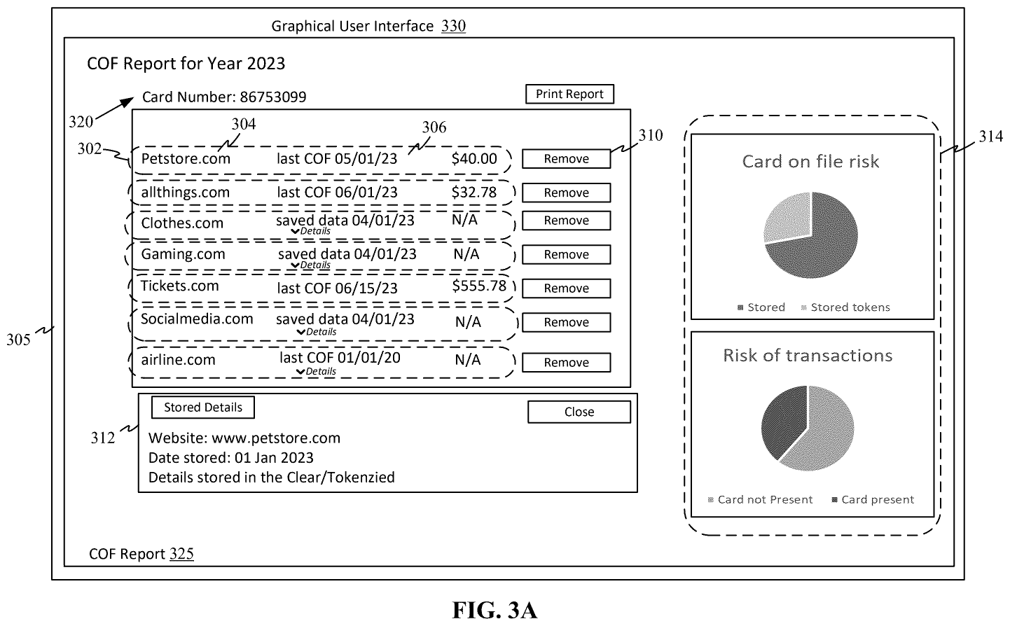

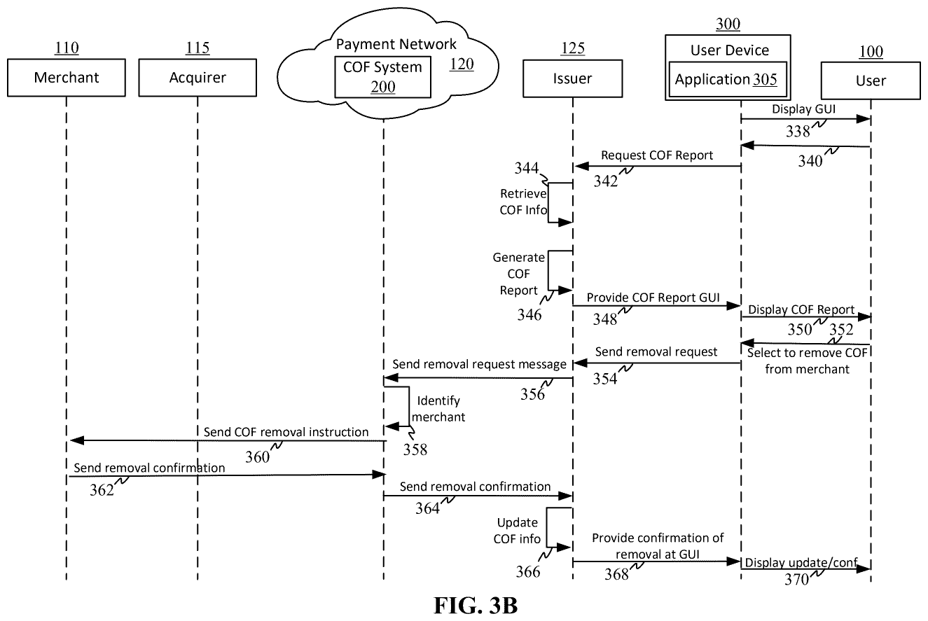

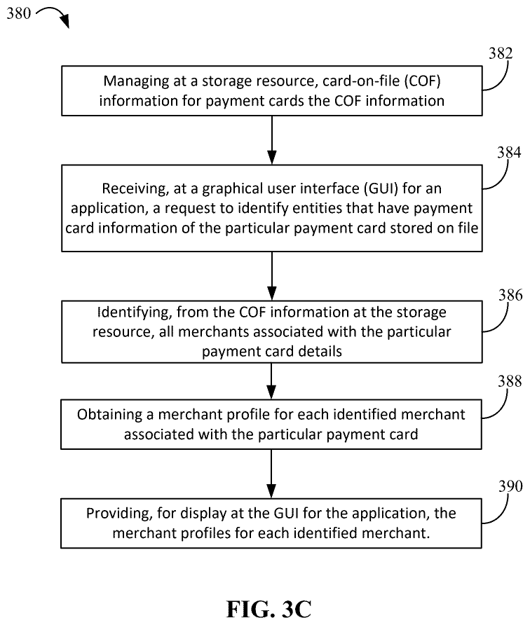

As such, the issuer 125 may use the COF information to generate a holistic report detailing the entities storing payment card details for a particular payment card. Additionally, the issuer 125 can provide enhanced functionality for their users, such as the ability to monitor and remove a payment card as a COF from a merchant (e.g., as described below in more detail with respect to FIGS. 3A-3C).

FIG. 3A illustrates an example representation of a graphical user interface of an interactive COF report for controlling stored data associated with payment card details at various entities; FIG. 3B illustrates a process flow diagram of controlling stored data associated with payment card details at various entities; and FIG. 3C illustrates an example method for controlling stored data associated with payment card details at various entities.

As a result of the ability to track storage of data associated with payment card details at various entities, an application feature can be provided that enables control of the stored data by the cardholder—even when payment card information is stored as part of a non-transaction event. Referring to FIG. 3A, an application, such as application 305 provided by an issuer 125, can include control functionality that enables improved security of the cardholder's data, including by presenting an interactive COF report 325 at a GUI 330 of the application 305.

As illustrated in FIG. 3A, GUI 330 can show the COF report 325 for a particular payment card (e.g., payment card 320). The COF report 325 displayed at GUI 330 can illustrate to a user each identified merchant storing payment card details of a particular payment card, such that the user is aware of which entities are storing payment card information of the particular payment card, even when no transaction has occurred at that entity. In some cases, the GUI 330 can further provide analytics 314, such as card on file risk or risk of transactions.

The COF report 325 includes COF information 302 and various functionality, including to remove a COF (e.g., through a remove command 310). The remove command 310 can indicate that a user wishes to remove a particular payment card, such as payment card 320 as a COF from the corresponding merchant indicated by the merchant name 304 of the COF information 302. Selecting the remove command 310 can trigger the process to remove the payment card information from the selected merchant (which can further enable an update to the analytics 314).

The COF information 302 includes a merchant profile associated with a merchant identifier (e.g., merchant name 304 and potentially other information about the merchant) and optionally context information 306 (e.g., information about when card was last used or indicated as stored) for each identified card on file, including for those merchants storing payment card details of a particular payment card during non-transaction events. Additional details can be expanded upon as well, for example, selection of one of the merchants in the COF information 302 can provide COF details 312.

In some cases, the COF information 302 includes the context information 306. The context information 306 can provide context for a user as to when payment card details for a particular payment card were stored by a merchant and/or during what kind of event (e.g., transaction or non-transaction event) payment card details for a particular payment card were stored by a merchant.

For example, where the particular payment card (e.g., payment card 320) was never used in a payment transaction at the corresponding merchant 304, the context information 306 can indicate a date that payment card details associated with the particular payment card were saved by the merchant (e.g., clothes.com stored payment card details on Apr. 1, 2023 even though there is no transaction).

As another example, where the particular payment card (e.g., payment card 320) was used in an authorized COF transaction at the corresponding merchant 304, the context information 306 can indicate a date the particular payment card was last used in a COF transaction and optionally the amount of that last transaction (e.g., COF transaction at petstore.com” on May 1, 2023 for $40.00).

In some cases, the COF information can be filtered to show only those merchants associated with non-transaction events or only those merchants associated with transaction events.

Referring to FIGS. 3A and 3B, a user 100 can access and view a graphical user interface of application 305 from their user device 300, which displays (338) the graphical user interface of application 305. In some cases, the application 305 is a web browser from which an issuer site is accessed. In some cases, application 305 is an application (mobile app or otherwise) provided by the issuer 125. The user 100, via the GUI provided by application 305 running on the user device 300, can interact (340) with the GUI to request (342) a COF report view for display at the GUI from the issuer 125. In some cases, the requested COF report view is for the particular payment card (e.g., payment card 320 of COF report 325 displayed in GUI 330 of FIG. 3A). In some cases, the requested COF report may include COF information for multiple payment cards.

Because the issuer 125 manages COF information for payment cards (for example, as described with respect to FIG. 1 and FIGS. 2A-2B), the issuer 125 can retrieve (344) the stored COF information and generate (346) a COF report 325. The issuer 125 can provide (348) the COF report 325 for display (350) in the GUI 330 at the user device 300.

Advantageously, the GUI 330 enables a cardholder to see where their card information is stored and remove the designated payment card as a COF from a particular merchant (e.g., via remove command 310). For example, if user 100 wishes to remove their payment card 320 as a COF from merchant 110, the user 100 can select (352) to remove the payment card as a COF at the GUI 330 displayed at the user device 300 (e.g., by selecting remove command 310 corresponding to that merchant). The application running on the user device 300 can send (354) the request to remove the payment card as a COF at the selected merchant in response to receiving the command.

In response to receiving the request to remove the payment card as a COF at the merchant 110 from the user device 300, the issuer 125 can send (356) a removal request message to the payment network 120. The removal request message may indicate that the user 100 is requesting the removal of the payment card as a COF from a particular merchant (e.g., merchant 110). In some cases, the removal request message includes a merchant ID associated with the merchant 110.

The payment network 120 can identify (358), from the merchant ID, the merchant 110 associated with the merchant ID. The payment network 120 can then send (360) a COF removal instruction to the merchant 110.

In some cases, sending (360) the COF removal instruction includes sending the COF removal instruction directly to the merchant 110 via APIs provided by the payment network 120 (e.g., MasterCard® Transaction Notifications API) for which the merchant 110 is registered.

In some cases, sending (360) the COF removal instruction includes generating and sending an NFA message to an acquirer 115 for communicating with the merchant 110.

Once the merchant 110 removes the payment card as a COF, the merchant 110 can send (362) confirmation to the payment network 120 that the payment card has been removed as a COF (e.g., the payment card details are no longer being stored by the merchant 110). The payment network 120 can then send (364) confirmation to the issuer 125 notifying the issuer 125 that the merchant 110 has removed the payment card as a COF.

When the issuer 125 receives confirmation that a payment card has been removed as a COF at a merchant 110, the issuer 125 can update (366) the COF information for the payment card to remove the selected merchant 110 from the COF information for that payment card. The issuer 125 can provide (368) for display (370) at the GUI at the application 305 on user device 300, confirmation that the merchant 110 has removed the payment card as a COF. For example, the confirmation provided for display (370) at the GUI can be a change in the visual appearance of the remove button (e.g., remove command 310), for example the remove command button may be grayed out or updated text saying “removed”). In some cases, the context information (e.g., context information 306) can be updated to reflect the change. In some cases, the merchant COF profile may be removed from the COF report. In some cases, a separate notification (e.g., communication, pop-up notification, etc.) can be provided to the user 100.

Accordingly, as illustrated in FIG. 3C, a method 380 of controlling stored data associated with payment card details at various entities can be carried out that includes managing (382), at a storage resource, card-on-file (COF) information for payment cards the COF information; receiving (384), at a graphical user interface (GUI) for an application, a request to identify entities that have payment card information of the particular payment card stored on file; identifying (386), from the COF information at the storage resource, all merchants associated with the particular payment card details; obtaining (388) a merchant profile for each identified merchant associated with the particular payment card; and providing (390), for display at the GUI for the application, the merchant profiles for each identified merchant.

The COF information can include merchant identifiers (IDs) of merchants storing payment card details of a particular payment card during non-transaction events and merchant IDs of merchants storing the payment card details of the particular payment card as part of a transaction that includes COF authorization.

As described in more detail with respect to FIG. 2A-2B, in some cases, managing (382) COF information for payment cards can include receiving, from a payment network, a non-financial advice (NFA) message comprising a COF notice, a first merchant ID, and first payment card information associated with the particular payment card, wherein the first merchant ID corresponds to a first merchant that received payment card details comprising the first payment card information during a non-transaction event; determining that the first merchant associated with the first merchant ID is not listed in the COF information for the particular payment card at the storage resource; storing the first merchant as COF information for the particular payment card at the storage resource; and sending confirmation to the payment network that the particular payment card is recorded as a COF associated with the first merchant.

As described in more detail with respect to FIG. 2A-2B, in some cases, managing (382) COF information for payment cards can include receiving, from the payment network, an authorization or preauthorization request associated with a transaction made using the particular payment card, the authorization or preauthorization request comprising a COF indicator, a second merchant ID, second payment card information associated with the particular payment card, and transaction information; determining that a second merchant associated with the merchant ID is not listed in the COF information for the particular payment card at the storage resource; storing the second merchant as COF information for the particular payment card at the storage resource; and sending confirmation to the payment network that the particular payment card is recorded as a COF with the second merchant.

Identifying (386) all merchants associated with the particular payment card can include identifying (386) any merchants that received the payment card details during non-transaction events.

Advantageously, the merchant profiles for each identified merchant are provided (390) for display at the GUI for the application (e.g., GUI 330 described with respect to FIG. 3A), such that a cardholder of the particular payment card is aware of which entities are storing the payment card information of the particular payment card, even when no transaction has occurred at that entity.

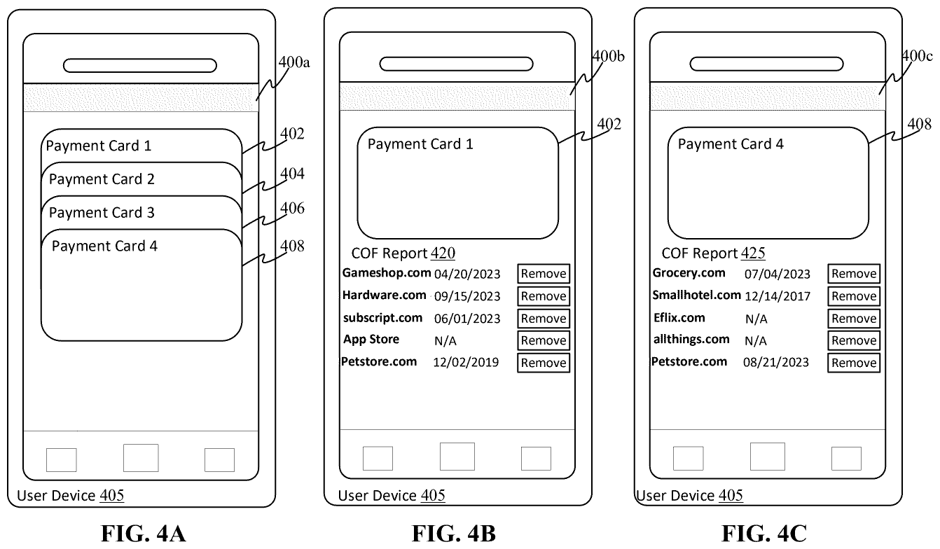

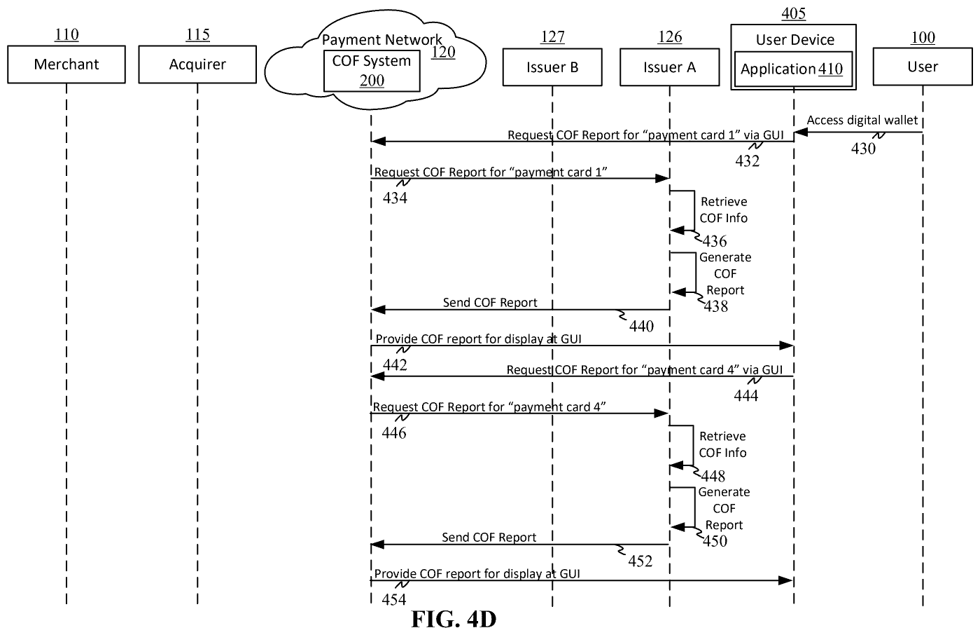

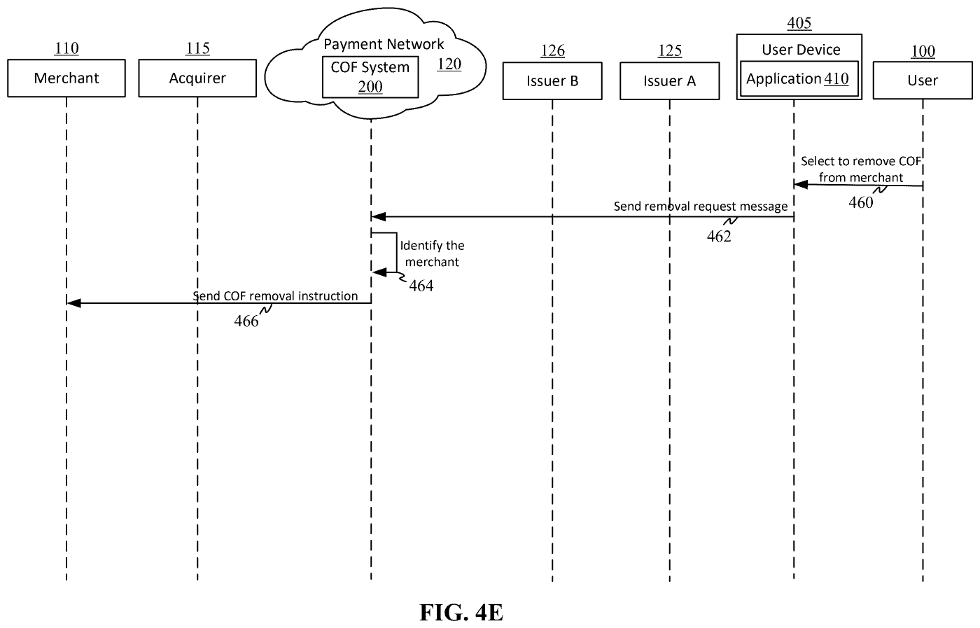

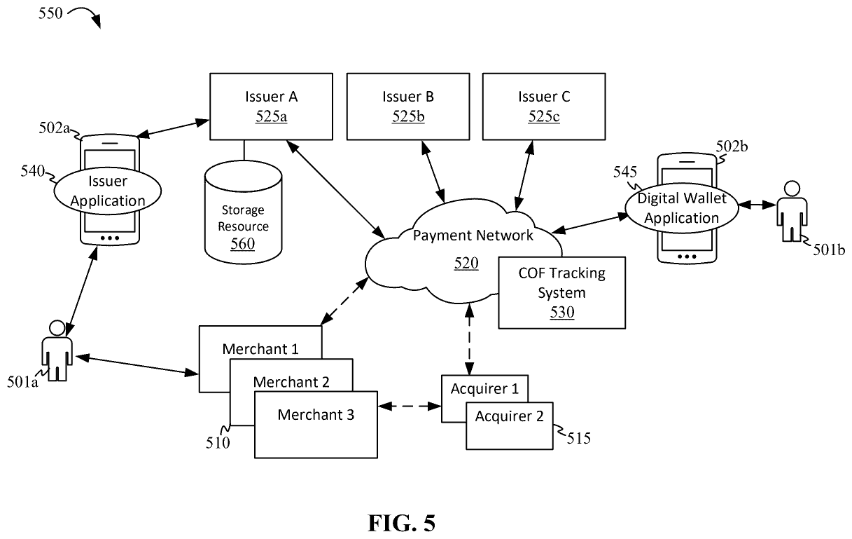

In some cases, method 380 is carried out by an issuer system (supported by related application 305). Thus method 380 may be performed by an issuer (e.g., issuer 125 as described with respect to FIG. 1, FIG. 2A-2B, FIG. 3A-3B, FIGS. 4A-4E, and FIG. 5). The issuer may have a storage resource (e.g., storage resource 560 as described with respect to FIG. 5). As described herein, the issuer can receive both transaction messages, including COF indicators (as described with respect to FIG. 1), and non-financial advice messages (as described with respect to FIGS. 2A-2B).

As described with more detail with respect to FIGS. 4A-4E, the method 380 can also include receiving an information request for the COF information for the particular payment card from a payment network to provide the COF information to a digital wallet application, wherein the digital wallet application is storing the particular payment card as a virtual payment card.

FIGS. 4A-4C illustrate a plurality of views of GUIs displayed at a digital wallet application. FIG. 4A illustrates an example representation of a “home” GUI at a digital wallet application. FIGS. 4B-4C illustrate example representations of interactive COF reports displayed in the graphical user interface at a digital wallet application.

FIG. 4D illustrates a process flow diagram for displaying a plurality of COF reports for a plurality of payment cards at a digital wallet application.

Referring to FIGS. 4A-4D, a user can access (430) a “home” view in a graphical user interface (GUI) 400a for a digital wallet application 410, for example, using user device 405. The digital wallet application 410 can be an online payment tool that securely stores virtual versions of payment cards (e.g., debit and credit cards) and is registered for communication with a payment network (e.g., payment network 120). The “home” view displayed in GUI 400a includes “payment card 1” 402, “payment card 2” 404, “payment card 3” 406, and “payment card 4” 408. The user 100 may desire to view a COF report for a particular payment card stored in their digital wallet application 410.

For example, during the process illustrated in FIG. 4D, the user 100 can select “payment card” 1 402 at GUI 400a of the digital wallet application 410 using the user device 405. In response, the digital wallet application 410 at the user device 405 can request (432) a COF report for “payment card 1” 402 from the payment network 120. In some cases, the request (432) is a non-financial advice message. The payment network 120 can request (434) a COF report for “payment card 1” 402 from issuer A 126 (e.g., the issuer associated with “payment card 1” 402). In some cases, the request (434) is a NFA message.

Issuer A 126 can retrieve (436) the stored COF information for “payment card 1” 402 and generate (438) a COF report for “payment card 1” 402. Issuer A 126 can send (440) the COF report to the payment network 120. In some cases, issuer A 126 can send (440) the COF report 420 to the payment network 120 via an NFA message. The payment network 120 can provide (442) the COF report (e.g., COF report 420) for display at the GUI 400a at the digital wallet application 410 of the user device 405.

Because the digital wallet application 410 may allow a user to virtually store a plurality of payment cards associated with a plurality of issuers, in some cases, the user 100 can select “payment card 4” 408 at GUI 400a of the digital wallet application 410 using the user device 405. In response, the digital wallet application 410 at the user device 405 can request (444) a COF report for “payment card 4” 408 from the payment network 120. In some cases, the request (444) is a non-financial advice message. The payment network 120 can request (446) a COF report for “payment card 4” 402 from issuer B 127 (e.g., the issuer associated with “payment card 4” 402). In some cases, the request (446) is an NFA message.

Issuer B 127 can retrieve (448) the stored COF information for “payment card 1” 402 and generate (450) a COF report for “payment card 4” 408. Issuer B 127 can send (452) the COF report to the payment network 120. In some cases, the issuer 125 can send (452) the COF report to the payment network 120 via an NFA message. The payment network 120 can provide (454) the COF report (e.g., COF report 425) for display at the GUI (e.g., GUI 400c) of the digital wallet application 410 of the user device 405.

While FIG. 4D illustrates issuer A 126 and issuer B 127 as separate issuers, in some cases, issuer A 126 and issuer B 127 can be the same issuer (e.g., “payment card 1” 402 and “payment card 4” 408 were both issued by the same issuer.

By accessing GUI 400b and/or GUI 400c via a digital wallet application 410 on the user device 405, the user 100 can view merchants where the selected payment card is stored as a COF. In some cases, the digital wallet application 410 at the user device 405 can simultaneously request a COF report for a plurality of payment cards (e.g., request (432) a COF report for “payment card 1” 402 and request (444) a COF report for “payment card 4” 408). As such, the digital wallet application may provide additional functionality for user 100, such as the functionality to search a plurality of COF reports simultaneously for a particular merchant. Advantageously, the user 100 could identify if any of a plurality of payment cards are being stored as a COF the specified merchant. In other words, if a user 100 was aware of a security breach at a particular merchant, that user 100 could search COF information for a plurality of payment cards simultaneously to determine if any payment card information is at risk.

Additionally, by accessing GUI 400b and/or GUI 400c via a digital wallet application 410 on the user device 405, the user 100 can select to remove a particular payment card as a COF at a particular merchant (e.g., merchant 110).

FIG. 4E illustrates a process flow diagram for requesting the removal of a particular payment card as a COF via a digital wallet application.

Referring to FIG. 4E, for example, if user 100 wishes to remove “payment card 1” 402 as a COF from merchant 110, the user 100 can select (460) to remove “payment card 1” 402 as a COF at a particular merchant via GUI 400b displayed at the user device 405 (e.g., by selecting a remove button corresponding to that merchant). The digital wallet application 410 running on the user device 405 can send (462) a removal request message to the payment network 120. The removal request message may indicate that the user 100 is requesting the removal of the payment card as a COF from a particular merchant (e.g., merchant 110). In some cases, the removal request message includes a merchant ID associated with the merchant 110.

The payment network 120 can identify (464), from the merchant ID, the merchant 110 associated with the merchant ID. The payment network 120 can then send (466) a COF removal instruction to the merchant 110.

In some cases, sending (466) the COF removal instruction includes sending the COF removal instruction directly to the merchant 110 via APIs provided by the payment network 120 (e.g., MasterCard® Transaction Notifications API) for which the merchant 110 is registered.

In some cases, sending (466) the COF removal instruction includes generating and sending an NFA message to an acquirer 115 for communicating with the merchant 110.

FIG. 5 illustrates an example operating environment for tracking and managing entities storing payment card information.

Referring to FIG. 5, operating environment 550 can include a plurality of users 501, including user 501a and user 501b (e.g., user 100 as described with respect to FIGS. 1, 2A-2B, 3A-3B, and 4A-4E) and various computing systems (e.g., formed of one or more processors, storage systems, networking interfaces and optional user interface components) associated with different entities. These various computing systems include a plurality of user devices, including user device 502a and user device 502b, a plurality of merchant systems 510 (e.g., for merchant 110 as described with respect to FIGS. 1, 2A-2B, 3A-3B, and 4A-4E), a plurality of acquirer systems 515 (e.g., for acquirer 115 as described with respect to FIGS. 1, 2A-2B, 3A-3B, and 4A-4E), a payment network 520 (e.g., payment network 120 as described with respect to FIGS. 1, 2A-2B, 3A-3B, and 4A-4E), a plurality of issuer systems 525, including issuer A 525a, issuer B 525b, and issuer C 525c (e.g., issuer 125 as described with respect to FIGS. 1, 2A-2B, 3A-3B, and issuer A 126 and issuer B 127 as described with respect to FIGS. 4A-4E). The operating environment 550 further includes an issuer application 540 (e.g., issuer application 305 as described with respect to FIGS. 3A-3B), and a digital wallet application 545 (e.g., digital wallet application 410 as described with respect to FIGS. 4A-4E), which can be executed at user devices. The payment network 520 can include a COF tracking system 530 (e.g., COF tracking system 200 described with respect to FIGS. 2A-2B, 3A-3B, and 4A-4E).

A user 501 can view COF reports at an issuer application 540 at a user device 502a (e.g., GUI 330 with COF report 325 as described with respect to FIG. 3B), or in some cases, at a digital wallet application 545 at a user device 502b (e.g., GUI 400b with COF report 420 as described with respect to FIG. 4B and GUI 400c with COF report 425 as described with respect to FIG. 4C).

The issuer application 540 at the user device 502a can communicate directly with the issuer that supports the issuer application 540 (e.g., Issuer A 525a) (e.g., as described with respect to FIGS. 3A-3C).

The digital wallet application 545 at the user device 502b can communicate directly with the payment network 520.

As illustrated by issuer A 525a, issuers 525 can include a storage resource (e.g., storage resource 560) for storing COF information. Storage resource 560 is any suitable storage system with computer-readable storage media capable of storing information (e.g., SRAM, DRAM, MRAM, flash, etc.). In some cases, the issuers 525 can provide COF information (e.g., as described with respect to FIGS. 3A-3C) directly to the issuer application 540. In some cases, the issuers 525 can provide COF information (e.g., as described with respect to FIGS. 4A-4E) to the payment network 520. The payment network 520 can facilitate communication between a plurality of issuers (e.g., issuers 525) and the digital wallet application 545 (e.g., as described with respect to FIGS. 4A-4E). For example, in some cases, the issuers 525 can provide COF information to the payment network 520 (e.g., as described with respect to FIGS. 4A-4E), and the payment network 520 can send the COF information to a digital wallet application 454.

The merchants 510 can communicate with acquirers 515 and the acquirers 515 can communicate with the payment network 520. In some cases, merchants 510 can communicate directly with the payment network 520, for example, via APIs provided by the payment network 520.

The acquirers 515, the payment network 520, and the issuers 525 are entities that are capable of sending and receiving transaction messages and non-financial advice messages over the payment network 520.

Embodiments of the described COF tracking system operations, the issuer application, and the digital wallet application may be implemented as a computer process, a computing system, or as an article of manufacture, such as a computer program product or computer-readable medium. Certain methods and processes described herein can be embodied as software, code and/or data, which may be stored on one or more storage media that when executed by one or more processor direct the system to perform the methods and processes described herein. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system/one or more processors) and encoding a computer program of instructions for executing a computer process. It should be understood that as used herein, in no case do the terms “storage media.” “computer-readable storage media” or “computer-readable storage medium” consist of transitory carrier waves or propagating signals. Instead, “storage” media refers to non-transitory media.

Communication to and from user computing devices, expense management platform, and various services described herein may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for tracking storage of payment card details at various entities, comprising:
receiving, over a payment network, a plurality of transaction messages and non-financial advice messages;
identifying, from the plurality of transaction messages and non-financial advice messages, a non-financial advice message comprising a card-on-file (COF) notice, a merchant identifier (ID), and payment card information of a payment card, wherein the merchant ID corresponds to a merchant that received payment card details comprising the payment card information during a non-transaction event;
identifying, from the payment card information, an issuer associated with the payment card details;
sending a COF message indicating storage of the payment card details at the merchant to the issuer; and
receiving, from the issuer, confirmation that the payment card is recorded as a COF.

2. The method of claim 1, further comprising:
identifying, from the plurality of transaction messages and non-financial advice messages, a transaction message comprising a COF indicator, a second merchant ID, second payment card information corresponding to a second payment card, and transaction information, wherein the second merchant ID corresponds to a second merchant at which a second payment card is authorized as a COF;
identifying, from the second payment card information, a second issuer associated with the second payment card;
requesting authorization or preauthorization for a second payment card corresponding to the second payment card information;
receiving, from the issuer, authorization or preauthorization for the second payment card corresponding to the second payment card information; and
receiving, from the issuer, confirmation that the second payment card is recorded as a second COF.

3. The method of claim 1, further comprising:
receiving a removal request message indicating that a user is requesting removal of the payment card as a COF at a particular merchant, wherein the removal request message comprises the merchant ID of the merchant;
identifying, from the merchant ID, the merchant associated with the merchant ID; and
sending a COF removal instruction to the merchant.

4. The method of claim 3, wherein the removal request message is received from an issuer.

5. The method of claim 3, wherein the removal request message is received from a digital wallet application.

6. The method of claim 3, wherein sending the COF removal instruction to the merchant comprises sending the COF removal instruction via a notification API of the payment network for which the merchant is registered.

7. The method of claim 3, wherein sending the COF removal instruction to the merchant comprises sending a non-financial advice message to an acquirer for communicating with the merchant.

8. A card-on-file (COF) tracking system, comprising:
one or more processors;
at least one storage system; and
instructions stored on the at least one storage system that when executed by the one or more processors, direct the COF tracking system to:
receive, over a payment network, a plurality of transaction messages and non-financial advice messages;
identify, from the plurality of transaction messages and non-financial advice messages, a non-financial advice message comprising a card-on-file (COF) notice, a merchant identifier (ID), and payment card information of a payment card, wherein the merchant ID corresponds to a merchant that received payment card details comprising the payment card information during a non-transaction event;
identify, from the payment card information, an issuer associated with the payment card details;
send a COF message indicating storage of the payment card details at the merchant to the issuer; and
receive, from the issuer, confirmation that the payment card is recorded as a COF.

9. The COF tracking system of claim 8, wherein the instructions further direct the system to:
identify, from the plurality of transaction messages and non-financial advice messages, a transaction message comprising a COF indicator, a second merchant ID, second payment card information corresponding to a second payment card, and transaction information, wherein the second merchant ID corresponds to a second merchant at which a second payment card is authorized as a COF;
identify, from the second payment card information, a second issuer associated with the second payment card;
request authorization or preauthorization for a second payment card corresponding to the second payment card information;
receive, from the issuer, authorization or preauthorization for the second payment card corresponding to the second payment card information; and
receive, from the issuer, confirmation that the second payment card is recorded as a second COF.

10. The COF tracking system of claim 8, wherein the instructions further direct the system to:
receive a removal request message indicating that a user is requesting removal of the payment card as a COF at a particular merchant, wherein the removal request message comprises the merchant ID of the merchant;
identify, from the merchant ID, the merchant associated with the merchant ID; and
send a COF removal instruction to the merchant.

11. The COF tracking system of claim 10, wherein the instructions to send the COF removal instruction to the merchant direct the system to:
send the COF removal instruction via a notification API of the payment network for which the merchant is registered.

12. The COF tracking system of claim 10, wherein the instructions to send the COF removal instruction to the merchant direct the system to:
send a non-financial advice message to an acquirer for communicating with the merchant.

13. A method, comprising:
managing, at a storage resource, card-on-file (COF) information for payment cards the COF information comprising merchant identifiers (IDs) of merchants storing payment card details of a particular payment card during non-transaction events and merchant IDs of merchants storing the payment card details of the particular payment card as part of a transaction that includes COF authorization;
receiving, at a graphical user interface (GUI) for an application, a request to identify entities that have payment card information of the particular payment card stored on file;
identifying, from the COF information at the storage resource, all merchants associated with the particular payment card, including any merchants that received the payment card details during non-transaction events;
obtaining a merchant profile for each identified merchant associated with the particular payment card; and
providing, for display at the GUI for the application, the merchant profiles for each identified merchant such that a cardholder of the particular payment card is aware of which entities are storing the payment card information of the particular payment card, even when no transaction has occurred at that entity.

14. The method of claim 13, wherein managing the COF information comprises:
receiving, from a payment network, a non-financial advice (NFA) message comprising a COF notice, a first merchant ID, and first payment card information associated with the particular payment card, wherein the first merchant ID corresponds to a first merchant that received payment card details comprising the first payment card information during a non-transaction event;
determining that the first merchant associated with the first merchant ID is not listed in the COF information for the particular payment card at the storage resource;
storing the first merchant as COF information for the particular payment card at the storage resource; and
sending confirmation to the payment network that the particular payment card is recorded as a COF associated with the first merchant.

15. The method of claim 14, wherein managing the COF information further comprises:
receiving, from the payment network, an authorization or preauthorization request associated with a transaction made using the particular payment card, the authorization or preauthorization request comprising a COF indicator, a second merchant ID, second payment card information associated with the particular payment card, and transaction information;
determining that a second merchant associated with the second merchant ID is not listed in the COF information for the particular payment card at the storage resource;
storing the second merchant as COF information for the particular payment card at the storage resource; and
sending confirmation to the payment network that the particular payment card is recorded as a COF with the second merchant.

16. The method of claim 13, further comprising:
receiving, at the graphical user interface for the application, a command indicating a request to remove the particular payment card as a COF at a selected merchant; and
sending a removal request message to a payment network, the removal request message indicating that a user is requesting removal of the particular payment card as a COF at a particular merchant, wherein the removal request message comprises a merchant ID associated with the selected merchant.

17. The method of claim 16, wherein the removal request message is a non-financial advice message.

18. The method of claim 16, further comprising:
receiving, from the payment network, confirmation that the selected merchant has removed the particular payment card as a COF;
updating the COF information for the particular payment card to remove the selected merchant from the COF information for the particular payment card; and
providing, for display at the GUI, confirmation that the selected merchant has removed the particular payment card as a COF.

19. The method of claim 13, further comprising receiving an information request for the COF information for the particular payment card from a payment network to provide the COF information to a digital wallet application, wherein the digital wallet application is storing the particular payment card as a virtual payment card.

20. The method of claim 13, wherein the merchant profile includes a merchant name and context information, wherein the context information indicates for the cardholder whether the particular payment card was used at the merchant associated with the merchant name during a transaction including COF authorization or during a non-transaction event.
